(19) United States
(12) Patent Application Publication
(10) Pub. No.: US 2011/0315657 A1
(43) Pub. Date: Dec. 29, 2011

(54) METHOD AND APPARATUS FOR MANUFACTURING GRAPHENE TRANSFER FILM

(75) Inventors: Se-hoon CHO, Changwon-city (KR); Young-il SONG, Changwon-city (KR)

(73) Assignee: SAMSUNG TECHWIN CO., LTD., Changwon-city (KR)

(21) Appl. No.: 13/172,162

(22) Filed: Jun. 29, 2011

(30) Foreign Application Priority Data
Jun. 29, 2010 (KR) 10-2010-0062096

(51) Int. Cl. B32B 37/02; B32B 38/10; B32B 37/10; B32B 37/14; B82Y 40/00

(52) U.S. Cl. 216/36; 156/285; 156/497; 977/842

(57) ABSTRACT

A method and an apparatus for manufacturing a graphene transfer film are provided. The method of manufacturing the graphene transfer film includes: forming graphene on a graphene growth film comprising a carbonization catalyst; disposing a carrier film and the graphene growth film so that the carrier film and the graphene growth film, on which the graphene is formed, face each other; applying air pressure to at least one of the graphene growth film and the carrier film so that the graphene and the carrier film are attached to each other; and removing at least a part of the graphene growth film.

CROSS-REFERENCE TO RELATED PATENT APPLICATION

This application claims priority from Korean Patent Application No. 10-2010-0062096, filed on Jun. 29, 2010, in the Korean Intellectual Property Office, the disclosure of which is incorporated herein in its entirety by reference.

### BACKGROUND

1. Field

Method and apparatus consistent with the exemplary embodiments relate to a method and apparatus for manufacturing a graphene transfer film.

2. Description of the Related Art

Graphene is a material obtained by connecting carbons with each other in a hexagonal form to constitute a honeycomb-formed two-dimensional planar structure, has a very small thickness, is transparent, and has great electric conductivity. Various attempts to apply graphene to a transparent display or a flexible display have been made using the above characteristics, and currently, attempts to form large area graphene are being made.

In general, graphene is formed on a catalytic metal by using chemical vapor deposition. Such graphene is transferred by using various methods according to a final product to be manufactured and is attached on a substrate such as a flexible printed circuit board (FPCB).

A graphene transfer film may be generally used as a medium for transferring graphene onto a substrate and is obtained by attaching graphene onto one surface of a carrier film. That is, a surface, on which graphene is formed, of a graphene transfer film contacts a substrate so as to attach the graphene thereon and a carrier film is removed, thereby finally transferring graphene onto the substrate.

### SUMMARY

One or more exemplary embodiments provide a method of manufacturing a graphene transfer film which may efficiently prevent graphene from being damaged while attaching a graphene growth film including a metal catalyst, on which graphene is formed, to a carrier film, and an apparatus for manufacturing the graphene transfer film.

According to an aspect of an exemplary embodiment, there is provided a method of manufacturing a graphene transfer film, the method including: forming graphene on a graphene growth film comprising a carbonization catalyst; disposing a carrier film and the graphene growth film so that the carrier film and the graphene growth film, on which the graphene is formed, face each other; applying air pressure to at least one of the graphene growth film and the carrier film so that the graphene and the carrier film are attached to each other; and removing at least a part of the graphene growth film.

According to an aspect of another exemplary embodiment, there is provided an apparatus for manufacturing a graphene transfer film, the apparatus including: a first transport system which transports a carrier film to a first location; a second transport system which transports a graphene growth film, on which graphene is formed, to a second location which faces the first location; a first air sprayer which applies air pressure to at least one of the carrier film at the first location and the graphene growth film at the second location so that the carrier film at the first location and the graphene growth film at the second location are attached to each other; and a graphene growth film remover which removes a part of the graphene growth film after the carrier film and the graphene growth film are attached to each other.

### BRIEF DESCRIPTION OF THE DRAWINGS

The above and other aspects will become more apparent by describing in detail exemplary embodiments with reference to the attached drawings, in which:

FIG. 1 illustrates an apparatus for manufacturing a graphene transfer film according to an exemplary embodiment;

FIG. 2 is an enlarged view of part II of FIG. 1, according to an exemplary embodiment;

FIG. 3 is an enlarged view of part III of FIG. 1, according to an exemplary embodiment;

FIG. 4 is an enlarged view of part IV of FIG. 1, according to an exemplary embodiment;

FIG. 5 is an enlarged view of part V of FIG. 1, according to an exemplary embodiment;

FIG. 6 is an enlarged view of part VI of FIG. 1, according to an exemplary embodiment;

FIG. 7 is a cross-sectional view schematically illustrating a first air spraying nozzle of the apparatus for manufacturing a graphene transfer film of FIG. 1, according to an exemplary embodiment;

FIG. 8 schematically illustrates an apparatus for manufacturing a graphene transfer film according to another exemplary embodiment;

FIG. 9 is a cross-sectional view of a graphene growth film according to another exemplary embodiment; and

FIG. 10 is a flowchart illustrating a method of manufacturing a graphene transfer film according to another exemplary embodiment.

### DETAILED DESCRIPTION OF THE EXEMPLARY EMBODIMENTS

Hereinafter, an apparatus for manufacturing a graphene transfer film according to an exemplary embodiment will be described with reference to the accompanying drawings.

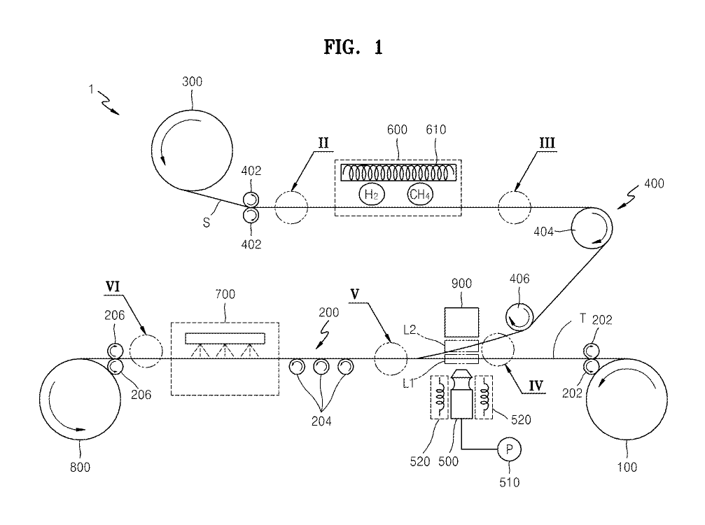

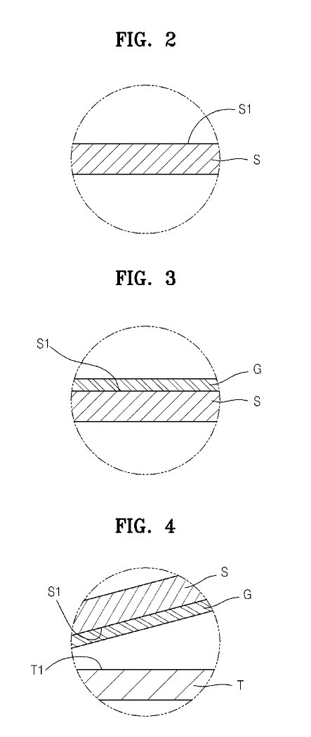

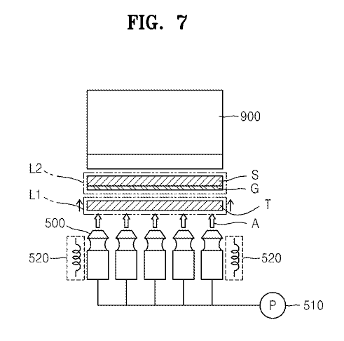

FIG. 1 illustrates an apparatus 1 for manufacturing a graphene transfer film according to an exemplary embodiment, FIGS. 2 through 6 are enlarged views of parts II through VI of FIG. 1, and FIG. 7 is a cross-sectional view schematically illustrating a first air spraying nozzle 500 of the apparatus 1 for manufacturing a graphene transfer film of FIG. 1.

Referring to FIGS. 1 through 7, the apparatus 1 for manufacturing a graphene transfer film according to the current exemplary embodiment includes a first reel 100, a first transport system 200, a second reel 300, a second transport system 400, a graphene synthesis chamber 600, the first air spraying nozzle 500, a support block 900, a graphene growth film remover 700, and a third reel 800.

The first reel 100 is disposed by being wound with a carrier film T. Various materials such as polydimethylsiloxane, polyethylen terephthalate (PET), a polyimide film, a polyurethane film, or glass may be used to form the carrier film T. Also, the carrier film T may be a thermal release film which loses adhesive strength at a predetermined temperature.

The first transport system 200 includes a plurality of rollers 202, 204, and 206, unwinds the carrier film T wound around the first reel 100, and transports the carrier film T in one direction. The first transport system 200 moves the carrier film T in one direction to be disposed at a first location L1 spaced apart from the first reel 100. The structure of the first transport system 200 is well-known to one of ordinary skill in the art, and thus, a detailed description thereof will be omitted here.

The second reel 300 is disposed by being wound with a graphene growth film S. The graphene growth film S includes a silicon material or a metal material. In the current exemplary embodiment, the graphene growth film S includes a copper (Cu) or nickel (Ni) material.

The graphene growth film S includes a carbonization catalyst so that graphene G is formed on a surface S1 of the graphene growth film S. Examples of the carbonization catalyst may include at least one selected from the group consisting of nickel (Ni), cobalt (Co), iron (Fe), platinum (Pt), gold (Au), aluminum (Al), chromium (Cr), copper (Cu), magnesium (Mg), manganese (Mn), roseum (Rh), silicon (Si), tantalum (Ta), titanium (Ti), tungsten (W), uranium (U), vanadium (V), and zirconium (Zr). In this exemplary embodiment, copper (Cu) or nickel (Ni) included in the graphene growth film S is used as the carbonization catalyst.

The second transport system 400 includes a plurality of rollers 402, 404, and 406 and transports the graphene growth film S wound around the second reel 300 while unwinding the graphene growth film S. The second transport system 400 transports the graphene growth film S to a second location L2 disposed at an upper side of the firs location L1 so that the graphene growth film S faces the carrier film T disposed at the first location L1 . That is, as illustrated in FIG. 7, the graphene growth film S disposed at the second location L2 and the carrier film T disposed at the first location L1 face each other. An interval between the first location L1 and the second location L2 may be a few millimeters or less. The structure of the second transport system 400 is well-known to one of ordinary skill in the art, and thus, a detailed description thereof will be omitted here.

The graphene synthesis chamber 600 is used to form the graphene G on the surface S1 that faces the carrier film T of the graphene growth film S, and is disposed on a transport path between the second reel 300 of the graphene growth film S and the second location L2. The graphene synthesis chamber 600 includes an inner space, and the graphene growth film S passes through the inner space. The inner space of the graphene synthesis chamber 600 includes a hydrogen gas and hydrocarbon gas, and maintains a high temperature by using a heating element 610. Accordingly, when the graphene growth film S passes through the inner space of the graphene synthesis chamber 600, the graphene G is formed on the surface of the graphene growth film S. In the current exemplary embodiment, the graphene G is formed only on the surface S1 that faces the carrier film T of the graphene growth film S, as illustrated in FIG. 3. However, the graphene G may be formed on both surfaces of the graphene growth film S including the surface S1 that faces the carrier film T. The graphene synthesis chamber 600 may be configured by being separated into two in order to easily synthesize the graphene G.

The first air spraying nozzle 500 is connected to a pneumatic pump 510 and blows air A. The first air spraying nozzle 500 is disposed at a lower side of the first location L1, and an air outlet hole thereof faces the first location L1. As illustrated in FIG. 7, a plurality of first air spraying nozzles 500 are disposed and are arranged at similar intervals in a direction perpendicular to a transport direction of the carrier film T. As illustrated in FIG. 7, when the first air spraying nozzles 500 applies air pressure to the carrier film T disposed at the first location L1 by spraying pressurized air A onto the carrier film T, the carrier film T at the first location L1 is attached on the graphene growth film S disposed at the second location L2.

In the current exemplary embodiment, the plurality of first air spraying nozzles 500 are disposed; however, just one first air spraying nozzle 500 may also be disposed. In particular, when one first air spraying nozzle 500 is disposed, the first air spraying nozzle 500 may be formed as an air knife which is extended in a direction so that an outlet end thereof crosses the transport direction of the carrier film T and a width of the first air spraying nozzle 500 is narrow. The first air spraying nozzle 500 may include a heating unit 520 to heat up air sprayed by the first air spraying nozzle 500. The temperature of air for the air pressure may be controlled to a predetermined threshold by the heating unit 520. For example, the temperature of air for the air pressure may be controlled to a temperature between room temperature and a release temperature of the thermal release film.

The support block 900 is disposed at an upper side of the second location L2 so that the first location L1 and the second location L2 are interposed between the first air spraying nozzle 500 and the support block 900. Accordingly, the carrier film T and the graphene growth film S pass through a space between the first air spraying nozzle 500 and the support block 900. The support block 900 prevents the carrier film T and the graphene growth film S from being pushed together by the air pressure of the first air spraying nozzle 500 so as to efficiently attach the carrier film T to the graphene growth film S.

In the current exemplary embodiment, the first air spraying nozzle 500 applies air pressure toward the carrier film T; however, the first air spraying nozzle 500 may be disposed to apply air pressure toward the graphene growth film S.

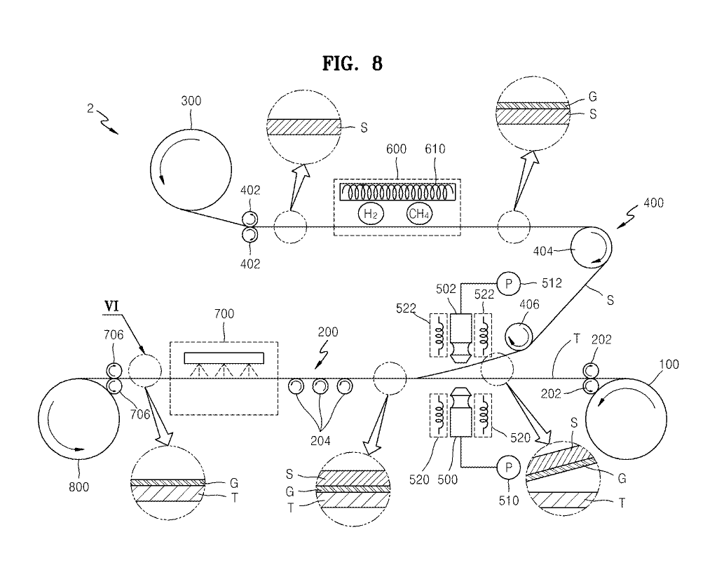

Also, as illustrated in FIG. 8, a second air spraying nozzle 502 disposed to face the first air spraying nozzle 500 may be included, instead of the support block 900. FIG. 8 schematically illustrates an apparatus 2 for manufacturing a graphene transfer film according to another exemplary embodiment, wherein the support block 900 of the apparatus 1 for manufacturing a graphene transfer film is replaced with the second air spraying nozzle 502. Referring to FIG. 8, the second air spraying nozzle 502 is disposed at an upper side of the second location L2 so that the first location L1 and the second location L2 are interposed between the first air spraying nozzle 500 and the second air spraying nozzle 502, and an injection hole of the second air spraying nozzle 502 is disposed to face the graphene growth film S. Accordingly, the second air spraying nozzle 502 closely adheres the graphene growth film S to the carrier film T along with the first air spraying nozzle 500. Similar to the first air spraying nozzle 500, the second air spraying nozzle 502 is connected to a pneumatic pump 512 and includes a heating unit 522. In the apparatus 2 for manufacturing a graphene transfer film including the first and second air spraying nozzles 500 and 502, the graphene growth film S and the carrier film T may be pressed in a non-contact manner so that the graphene G may be efficiently prevented from being damaged during transfer onto the carrier film T.

The graphene growth film remover 700 is used to only remove the graphene growth film S from the carrier film T, on which the graphene growth film S is attached, and is disposed after the first location L1 on the transport path of the carrier film T. The graphene growth film remover 700 applies an etching solution to the carrier film T, on which the graphene growth film S is attached, while passing the first location L1, so as to only remove the graphene growth film S. Accordingly, only the graphene G remains on the carrier film T which passes the graphene growth film remover 700.

The third reel 800 corresponds to the first reel 100 and is disposed by being wound with the carrier film T, which unwinds from the first reel 100 and passes the first location L1 and the graphene growth film remover 700.

Next, a method of manufacturing a graphene transfer film according to another exemplary embodiment will be described more fully with reference to the accompanying drawings. In the current exemplary embodiment, the apparatus 1 for manufacturing a graphene transfer film is used.

Referring to FIG. 10, the method of manufacturing a graphene transfer film includes:

i. forming the graphene G on the surface S1 of the graphene growth film S (operation ST10);

ii. disposing the graphene growth film S and the carrier film T so that the surface S1 of the graphene growth film S, on which the graphene G is formed, and the carrier film T face each other (operation ST20);

iii. applying air pressure to the carrier film T so that the graphene growth film S and the carrier film T are attached to each other (operation ST30); and

iv. etching and removing the graphene growth film S attached on the carrier film (operation ST 40).

Firstly, the graphene G is formed on the surface S1 of the graphene growth film S (in operation ST10).

While hydrogen gas and hydrocarbon gas are injected into the graphene synthesis chamber 600, and the inner space of the graphene synthesis chamber 600 is maintained at a high temperature, the second transport system 400 is operated so that the graphene growth film S of the second reel 300 is transported to the graphene synthesis chamber 600. When the graphene growth film S is transported to the graphene synthesis chamber 600, the graphene G is formed on the surface including the surface S1 of the graphene growth film S by the carbonization catalyst. That is, the graphene growth film S in FIG. 2 passes through the graphene synthesis chamber 600, and the graphene G is formed on the surface S1, as illustrated in FIG. 3.

Then, the graphene growth film S and the carrier film T are disposed so that the surface S1 of the graphene growth film S, on which the graphene G is formed, faces the carrier film T (in operation ST20).

The second transport system 400 is continuously operated so that the graphene growth film S that passes through the graphene synthesis chamber 600 is transported to the second location L2. Also, the first transport system 200 is operated so that the carrier film T is transported to the first location L1. The second transport system 400 is configured for the surface S1 of the graphene growth film S, on which the graphene G is formed, to face the carrier film T, when the graphene growth film S is transported to the second location L2. Thus, as illustrated in FIG. 4, the graphene growth film S is transported to the second location L2 and the surface S1, on which the graphene G is formed, faces the carrier film T. When the carrier film T and the graphene growth film S are transported to the first location L1 and the second location L2 by the first transport system 200 and the second transport system 400, respectively, the carrier film T and the surface S1 of the graphene growth film S, on which the graphene G is formed, face each other, as illustrated in FIG. 7.

Then, air is applied to the carrier film T so that the graphene growth film S and the carrier film T are attached to each other (in operation ST30).

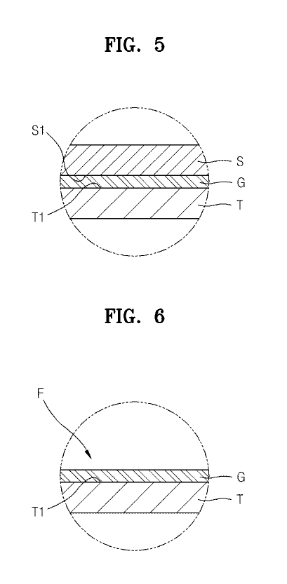

As illustrated in FIG. 7, when the carrier film T is disposed at the first location L1 and the graphene growth film S is disposed at the second location L2, the plurality of first air spraying nozzles 500 spray air A onto the carrier film T and the air from the air spraying nozzles 500, therefore, pushes the carrier film T. Due to the pressure applied by the first air spraying nozzles 500, the carrier film T is pushed toward the graphene growth film S, and thus, is attached to the graphene growth film S. That is, as illustrated in FIG. 5, the graphene growth film S is attached on the carrier film T which passes the first location L1. Here, pressure of the air A sprayed onto the graphene G from the first air spraying nozzles 500 is appropriately controlled so that excessive pressure is not applied to the graphene G.

A heating of the air A that presses the carrier film T (operation ST32) is further included in operation ST30. When the heating of the air A that presses the carrier film T is further included, the air A presses the carrier film T and heats the carrier film T so that the carrier film T may be attached securely to the graphene growth film S.

Also, when the carrier film T is heated, flexibility and softness of the carrier film T may be increased. Therefore, even if the carrier film T or the graphene G has uneven surfaces, the carrier film T and the graphene G may be stably adhered to each other.

In operation ST32, when the carrier film T is a thermal release film, temperature of the air A may not exceed a release temperature of the thermal release film.

Then, the graphene growth film S is etched and removed (in operation ST40).

The first transport system 200 is continuously operated so that the carrier film T, which passes the first location L1, and on which the graphene growth film S is attached, is entered into the graphene growth film remover 700. In the graphene growth film remover 700, an etching solution is applied to the carrier film T, on which the graphene growth film S is attached, and only the graphene growth film S is removed. Accordingly, when the carrier film T passes the graphene growth film remover 700, only the graphene G is left on a surface T1 of the carrier film T, as illustrated in FIG. 6. That is, a graphene transfer film F obtained by attaching the graphene G on the carrier film T is manufactured. The graphene transfer film F is continuously transported by the first transport system 200, and is wound around the third reel 800.

In the current exemplary embodiment, in the removing of the graphene growth film S (in operation ST40), the graphene growth film S is entirely removed. However, in the removing of the graphene growth film S (in operation ST40), a predetermined pattern of the graphene growth film S may be removed. In order to remove the predetermined pattern of the graphene growth film S, an etching resist is patterned on a surface opposite to the surface S1, on which the graphene S is formed, of the graphene growth film S, and thus, only a desired portion may be removed by etching. As such, when the graphene growth film S that remains after the predetermined pattern of the graphene growth film S is removed is used as a graphene removing resist, only the graphene G exposed through a portion, where the graphene growth film S is removed, may be removed. Accordingly, a pattern, in which the graphene growth film S and the graphene G are stacked, may be generated and may be attached on a substrate through a secondary transferring process. As such, when the graphene growth film S and the graphene G are patterned, the graphene G may be transferred onto the substrate in a predetermined pattern. A large amount of the graphene transfer film F wound around the third reel 800 is used to transfer the graphene G onto a flexible circuit board. That is, when the surface of the graphene transfer film F, on which the graphene G is formed, contacts the flexible circuit board and only the carrier film T is removed, the graphene G may be transferred onto the flexible circuit board. When a thermal release film is used as the carrier film T and the carrier film T is heated, the adhesive strength of the carrier film T is rendered ineffective, and thus, the carrier film T may be easily separated from the graphene G.

As such, in the apparatus 1 for manufacturing a graphene transfer film and the method of manufacturing the graphene transfer film F according to the exemplary embodiments, air pressure is used to attach the graphene growth film S to the carrier film T so that the graphene growth film S and the carrier film T may be uniformly and softly pressed and an excessive mechanical shock may not be applied to the graphene G. Accordingly, the graphene G may be efficiently prevented from being damaged during attaching of the graphene growth film S to the carrier film T. In the apparatus 2 for manufacturing a graphene transfer film of FIG. 8 including the first and second air spraying nozzles 500 and 502 at both upper and lower sides of the first and second locations L1 and L2, the graphene growth film S and the carrier film T may be pressed in a non-contact manner using air pressure so that the graphene G formed on the graphene growth film S may be efficiently prevented from being damaged while being transferred onto the carrier film T.

Also, according to the apparatus 1 for manufacturing a graphene transfer film, since the carrier film T is pressed in a non-contact manner using air pressure, even if the thicknesses of the graphene G, the graphene growth film S, and the carrier film T vary, the locations of the first air spraying nozzle 500 and the support block 900 do not need to be reset. That is, when pressing using a pair of rollers, there is a need to adjust a gap in order to appropriately press according to the states and thicknesses of the graphene G and the carrier film T. However, in the apparatus 1 for manufacturing a graphene transfer film, such a need is low. Also, even if unevenness or patterns are present on the surface of the carrier film T or graphene G, the carrier film T and the graphene G may be stably attached to each other. The apparatus 2 for manufacturing a graphene transfer film of FIG. 8 is similar to the apparatus 1 for manufacturing a graphene transfer film.

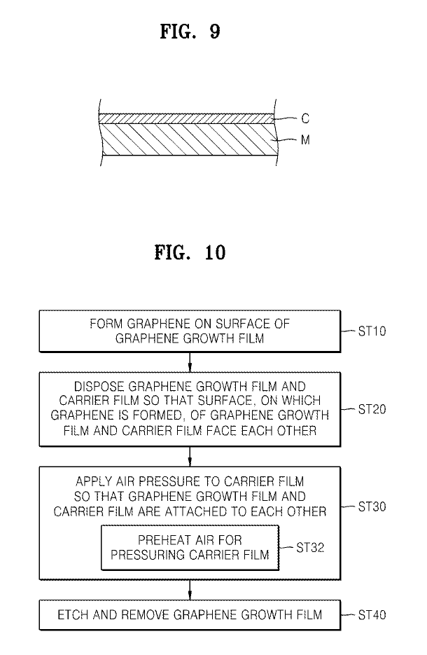

In the above exemplary embodiments, the graphene growth film S includes a copper (Cu) or nickel (Ni) material, and thus, does not include a separate carbonization catalyst layer. However, the graphene growth film S may include a separate carbonization catalyst layer. For example, as illustrated in FIG. 9, the graphene growth film S may include a base film M including a silicon or polymer material and a carbonization catalyst layer C, which includes a carbonization catalyst such as copper, disposed on the base film M.

Also, in the method of manufacturing the graphene transfer film according to the above exemplary embodiments, the graphene growth film S and the carrier film T wound around reels are used. However, in the method of manufacturing the graphene transfer film, a segment type graphene transfer film or carrier film may be used.

In addition, in the method of manufacturing the graphene transfer film according to the above exemplary embodiments, applying air using the first air spraying nozzle 500 may further include heating of the air. However, according to other exemplary embodiments, the heating of the air may not be performed. That is, the carrier film T and the graphene growth film S, on which the graphene G is formed, may be pressed toward each other by the sprayed air which is not heated.

In the above exemplary embodiments, the graphene growth film S is removed using a chemical method by etching; however, the graphene growth film S may also be removed by using a mechanical method.

Also, in the above embodiment, the graphene transfer film F is continuously wound around the third reel 800 however, the graphene transfer film F may not be wound around the third reel 800 and may be formed into many individual segments with an appropriate dimension.

In the method and apparatus for manufacturing the graphene transfer film according to the above exemplary embodiments, graphene may be efficiently prevented from being damaged while attaching the graphene to the carrier film.

While the above exemplary embodiments have been particularly shown and described with reference to the drawings, it will be understood by those of ordinary skill in the art that various changes in form and details may be made therein without departing from the spirit and scope of the inventive concept as defined by the following claims.

1. A method of manufacturing a graphene transfer film, the method comprising:
forming graphene on a graphene growth film comprising a carbonization catalyst;
disposing a carrier film and the graphene growth film so that the carrier film and the graphene growth film, on which the graphene is formed, face each other;
applying air pressure to at least one of the graphene growth film and the carrier film so that the graphene and the carrier film are attached to each other; and
removing at least a part of the graphene growth film.

2. The method of claim 1, wherein the carbonization catalyst comprises at least one selected from the group consisting of nickel (Ni), cobalt (Co), iron (Fe), platinum (Pt), gold (Au), aluminum (Al), chromium (Cr), copper (Cu), magnesium (Mg), manganese (Mn), roseum (Rh), silicon (Si), tantalum (Ta), titanium (Ti), tungsten (W), uranium (U), vanadium (V), and zirconium (Zr).

3. The method of claim 1, wherein the graphene growth film are formed by a metal material comprising the carbonization catalyst.

4. The method of claim 1, wherein the graphene growth film comprises:
a base film; and
a carbonization catalyst layer formed on the base film and comprising the carbonization catalyst.

5. The method of claim 1, wherein the carrier film is a thermal release film.

6. The method of claim 5, wherein a temperature of air for the air pressure is controlled to a predetermined threshold.

7. The method of claim 1, wherein in the removing the at least a part of the graphene growth film, the at least a part of the graphene growth film is removed by etching.

8. The method of claim 7, wherein the removing the at least a part of the graphene growth film comprises forming an etching resist in a predetermined pattern onto the graphene growth film before the etching the growth film.

9. The method of claim 1, wherein the applying air pressure comprises heating air for the air pressure.

10. The method of claim 1, wherein in the removing the graphene growth film, the graphene growth film is removed according to a predetermined pattern.

11. The method of claim 1, wherein the applying air pressure to the at least one of the graphene growth film and the carrier film comprises attaching the graphene growth film and the carrier film by applying air pressure to the carrier film while the graphene growth film is supported by a support block.

12. The method of claim 1, wherein the applying air pressure comprises applying the air pressure to at least one of:
a first surface of the carrier film opposite to a second surface thereof facing the graphene growth film; and
a first surface of the graphene growth film opposite to a second surface thereof facing the carrier film.

13. An apparatus for manufacturing a graphene transfer film, the apparatus comprising:
a first transport system which transports a carrier film to a first location;
a second transport system which transports a graphene growth film, on which graphene is formed, to a second location which faces the first location;
a first air sprayer which applies air pressure to at least one of the carrier film at the first location and the graphene growth film at the second location so that the carrier film at the first location and the graphene growth film at the second location are attached to each other; and
a graphene growth film remover which removes at least a part of the graphene growth film after the carrier film and the graphene growth film are attached to each other.

14. The apparatus of claim 13, wherein, in applying the air pressure, the first air sprayer applies the air pressure to at least one of:
a first surface of the carrier film opposite to a second surface thereof facing the graphene growth film; and
a first surface of the graphene growth film opposite to a second surface thereof facing the carrier film.

15. The apparatus of claim 13, further comprising a support block disposed to face the first air sprayer so that the first location and the second location are interposed between the first air spraying nozzle and the support block.

16. The apparatus of claim 13, further comprising a second air sprayer which applies another air pressure to the at least one of the carrier film at the first location and the graphene growth film at the second location, from a direction opposite to a direction of the air pressure applied by the first air sprayer.

17. The apparatus of claim 13, wherein the first air sprayer further comprises a heating unit for heating air for the air pressure.

18. The apparatus of claim 13, wherein the first air sprayer comprises a plurality of the air spraying nozzles and the plurality of the first air spraying nozzles are arranged in a direction perpendicular to a transport direction of the carrier film.

19. The apparatus of claim 13, further comprising:
a first reel which is wound with the carrier film and provides the carrier film to the first transport system;
a second reel which is wound with and provides the graphene growth film to the second transport system; and
a graphene synthesis chamber which receives the graphene growth film from the second reel, forms the graphene on the graphene growth film, and provides the graphene growth film, on which the graphene is formed, to the second transport system.

20. The apparatus of claim 13, wherein a temperature of air for the air pressure is controlled to a predetermined threshold.
